(19) United States
(12) Patent Application Publication
(10) Pub. No.: US 2015/0222498 A1
(43) Pub. Date: Aug. 6, 2015

(54) FASTER FLOWSHEET DESIGN BY PREDICTIVE CONNECTIVITY

(71) Applicant: Invensys Systems, Inc., Foxboro, MA (US)

(72) Inventor: Harry Scott Brown, Yorba Linda, CA (US)

(73) Assignee: INVENSYS SYSTEMS, INC., Foxboro, MA (US)

(21) Appl. No.: 14/525,964

(22) Filed: Oct. 28, 2014

Related U.S. Application Data
(60) Provisional application No. 61/934,922, filed on Feb. 3, 2014.

(51) Int. Cl. H04L 12/24; G06F 3/0484; G06F 17/50

(52) U.S. Cl. CPC H04L 41/22; G06F 17/50; G06F 3/04842

(57) ABSTRACT

A computer-implemented method and system presents a mini-palette of candidate objects to a user in a graphical flowsheet design program. The user is enabled to choose a candidate object for inclusion in the flowsheet. In response to an indication from the user to initiate a new connection from an output port of an object currently displayed on the flowsheet, a set of one or more candidate objects is predicted by applying a set of rules to a plurality of previously designed flowsheets. Finally, the set of candidate objects is displayed to the user in a mini-palette for selection of an object to be included in the flowsheet.

### BACKGROUND

Process control engineers and the like use flowsheets to represent process control systems that are to be monitored and/or controlled. Process simulation model components are represented in the context of process simulation software by objects. Objects are used by process simulation software to create simulation models that represent plant operations. One object may represent a process model component (a “unit”), such as a valve, connected to another process unit, such as a pump. During the creation of the model, a connection (called a “stream”) must be made between the units; typically between ports on the units. Stretching streams between object ports can prove tedious, in that this connection process must be repeated many times over to complete the construction of a model. The connection process can be made easier for a user by reducing the time and steps required to complete a connection.

As a user designs a flowsheet, it is necessary to add objects to the flowsheet and connect them to other objects. Through repeated adding and connecting actions, the flowsheet eventually contains numerous objects connected in a variety of ways to represent an actual or simulated process control system. Typically, users must choose objects from a large library of different objects as they are building flowsheets. Even if this library of objects is organized, users often spend large amounts of time looking through it for the right objects to include in their flowsheets. Because flowsheet design software allows users to design different types of flowsheets and these different types of flowsheets may call for different types of objects, typical object libraries contain large quantities of objects that a particular user will never use. Nevertheless, this user would still have to scroll past or search through these objects to get to the desired object.

The ability to predict objects that a user will likely desire to include in a flowsheet and to present these predicted objects to the user in a clear way would improve flowsheet design and cut down on excessive time spent searching through large libraries of objects, allowing the flowsheet design process to become more efficient.

### SUMMARY

Briefly described, aspects of the present invention relate to a special-purpose computer executing a program enabling a user to design flowsheets that represent process control systems. Such program, when executed, provides a mini-palette of candidate objects to a user in a graphical flowsheet design program. A set of rules applied to previously designed flowsheets predicts candidate objects for inclusion in the flowsheet and presents them on the mini-palette to improve flowsheet design.

In one aspect, a computer-implemented method presents a mini-palette of candidate objects to a user in a graphical flowsheet design program. The user is enabled to choose a candidate object for inclusion in the flowsheet. The method comprises receiving an indication from the user to initiate a new connection from an output port of an object currently displayed on the flowsheet. The method determines a set of one or more candidate objects by applying a set of rules to a plurality of previously designed flowsheets. Further, the method displays the set of candidate objects to the user in a mini-palette and enables the user to select an object for inclusion in the flowsheet.

In another aspect, a non-transitory computer readable medium stores instructions that present a mini-palette of candidate objects to a user in a graphical flowsheet design program. The user is enabled to choose a candidate object for inclusion in the flowsheet. The instructions comprise receiving an indication from the user to initiate a new connection from an output port of an object currently displayed on the flowsheet. The instructions determine a set of one or more candidate objects by applying a set of rules to a plurality of previously designed flowsheets. And the instructions display the set of candidate objects to the user in a mini-palette and enable the user to select an object for inclusion in the flowsheet.

In yet another aspect, a system executes instructions that present a mini-palette of candidate objects to a user in a graphical flowsheet design program. The user is enabled to choose a candidate object for inclusion in the flowsheet. The system receives an indication from the user to initiate a new connection from an output port of an object currently displayed on the flowsheet. The system determines a set of one or more candidate objects by applying a set of rules to a plurality of previously designed flowsheets. Further, the system displays the set of candidate objects to the user in a mini-palette and enables the user to select an object for inclusion in the flowsheet.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 shows an exemplary screenshot of a flowsheet design program including the mini-palette according to an embodiment of the invention.

FIG. 2 shows a portion of an exemplary screenshot of the flowsheet design program of FIG. 1 after a candidate object has been selected from the mini-palette and the candidate object has been placed on the canvas and connected to the object.

FIG. 3 is an exemplary flow diagram illustrating aspects of the process of the system according to an embodiment of the invention.

FIG. 4 is an exemplary flow diagram illustrating aspects of a candidate object prediction process for use in the process of FIG. 3.

Corresponding reference characters indicate corresponding parts throughout the drawings.

### DETAILED DESCRIPTION

A system embodying aspects of the invention simplifies the design process of flowsheets in flowsheet design software. Flowsheet design software is executable on a computer system having a processor, memory, and other typical computer elements. When using this system, a user can minimize time spent searching through lists of potential objects for a desired object. As such, the number of times the user must click a mouse, for example, or otherwise interact with the system decreases significantly. Advantageously, aspects of the invention thus improve the user's ability to design a flowsheet.

Moreover, aspects of the present invention predict the most likely candidate objects based on a variety of factors and display the candidate objects in a way that the user can then choose the correct object if it is present. In the event that the system does not predict the correct object, the user can still return to the main list of objects and search for it in that manner; however the correct object will be predicted and among the candidate objects a significant portion of the time, allowing the user to forgo searching through the main list.

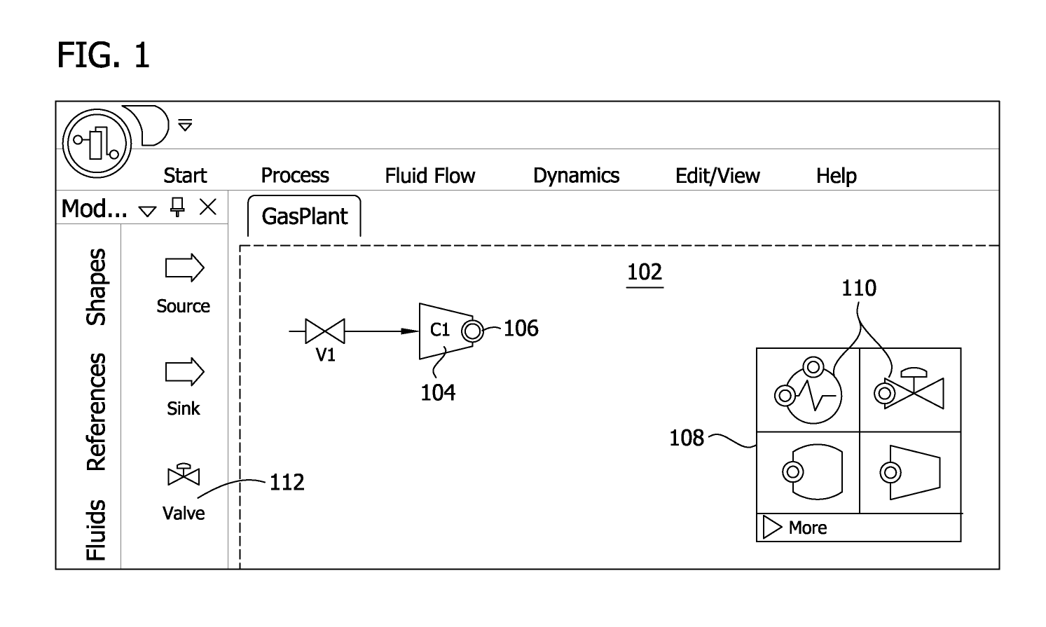

FIG. 1 shows an exemplary screenshot of a flowsheet canvas 102 on which a user has placed a present object 104 and invoked a mini-palette 108 according to an embodiment of the invention. The mini-palette 108 contains candidate objects 110 that the system has predicted to be the most likely objects for connection to the present object 104. In an embodiment, the main method of prediction uses an analysis of a large library of realistically designed flowsheets. As a user indicates that he or she wishes to add a new object connected to present objects 104 on the canvas 102, the system analyzes the library of designed flowsheets to determine which objects are most often connected to the present object 104 in this manner. Upon determining the most likely candidate objects 110, the system presents the candidate objects to the user so the user can select the desired object.

In an embodiment, the flowsheet is being constructed in a flowsheet design program that presents a palette of objects 112 associated with the canvas 102 on which selected objects are placed and connected to one another. As shown in the example of FIG. 1, the current canvas 102 contains two connected objects, V1 and C1, which is present object 104 in the illustrated embodiment. The present object 104, C1, has a connection point 106 that has been selected by the user. As a result of the user indicating a desire to connect a new object to the connection point 106, the system executes a set of rules to predict four, for example, most likely new candidate objects 110. Once predicted, the system displays the candidate objects 110 in the mini-palette 108. Each candidate object 110 is displayed as a simple image that is indicative of what the object represents. Moreover, within the mini-palette 108, the system highlights the potential connection points to the user. In operation, when the user selects one of the connection points on one of the candidate objects 110, the mini-palette 108 closes and the selected candidate object 110 is added to the flowsheet. From there, the user may continue adding new objects to the flowsheet from either the palette 112 or any additional mini-palettes 108 that may appear as a result of attempting to connect an object. Although described in terms of a two-click operation, it is to be understood that other operations for selecting and connecting candidate objects could be employed, such as drag-and-drop.

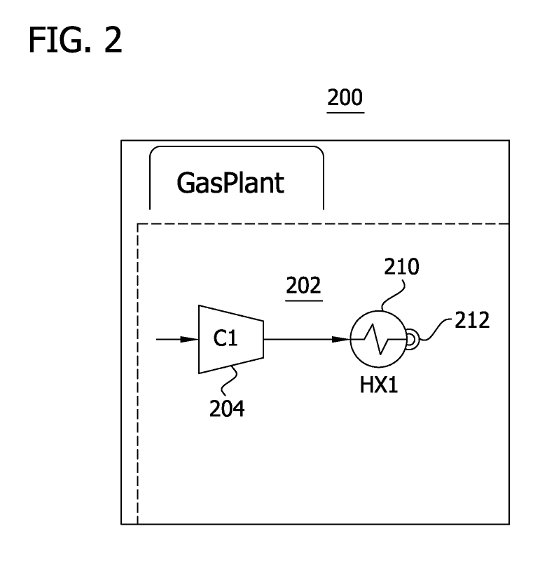

FIG. 2 shows a portion of a flowsheet 200 from FIG. 1 after the user has selected a candidate object 110 from the mini-palette 108 and connected it to the connection point 106 previously highlighted on present object 104, C1. The successful selection and connection of a desired candidate object 210 causes the mini-palette 108 to disappear from the screen and the selected candidate object 210 is displayed on the canvas 202 as added to the flowsheet and connected to a present object 204, which is indicated C1 in the illustrated embodiment. As shown in the example of FIG. 2, a connection point 212 is visible on the right of the recently added object 210.

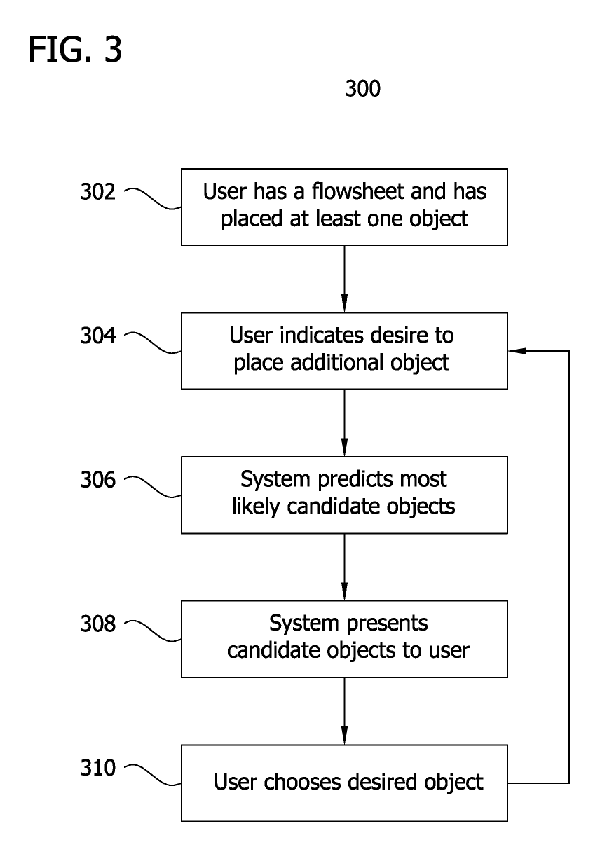

FIG. 3 illustrates operation of the described system in an exemplary flow diagram. Beginning at a starting point 302, the user opens a flowsheet and places at least one object on the flowsheet canvas. The system of predicting candidate objects functions based on having at least one object that it can use to analyze the design library for data on the previous and expected relationships of that object. Once the user places an object on the flowsheet, the user indicates a desire to place an additional object (step 304). The user can indicate this in a variety of ways. FIG. 1 shows the user indicating this desire by interacting with a connection point on an object. It is to be understood that this user input can be from any user input source without deviating from aspects of the invention. For instance, a user might indicate the desire to connect an additional object with a mouse-click or a key press on a keyboard. Additionally, a user could indicate by touching a touchscreen interface or by voice recognition software. These are merely examples and are not intended to limit the methods with which a user can indicate their desire to place an additional object on the flowsheet.

Referring further to FIG. 3, at step 306, the system detects the user's indication to add a new object and predicts, based on the current objects present and other information, which candidate objects are most likely to be added to the flowsheet next. The prediction process will be further described below.

At step 308, the system presents the predicted candidate object(s) to the user for selection. The display of the candidate objects is preferably in the form of a mini-palette. FIG. 1 illustrates an exemplary mini-palette represented as a square grid that shows four simple images representative of the candidate objects. However, the mini-palette need not take the form of a square grid. The mini-palette could be in a list format, or the candidate objects could be represented by text rather than simple images. The mini-palette may contain more or less than four candidate objects as well.

Once the user chooses a desired object (step 310), the system executes further instructions enabling the user to add another object to the flowsheet (step 304). In the event that the mini-palette does not contain the object that the user desires, the user can fall back on a different method of placing a new object, such as using the main palette as shown in FIG. 1.

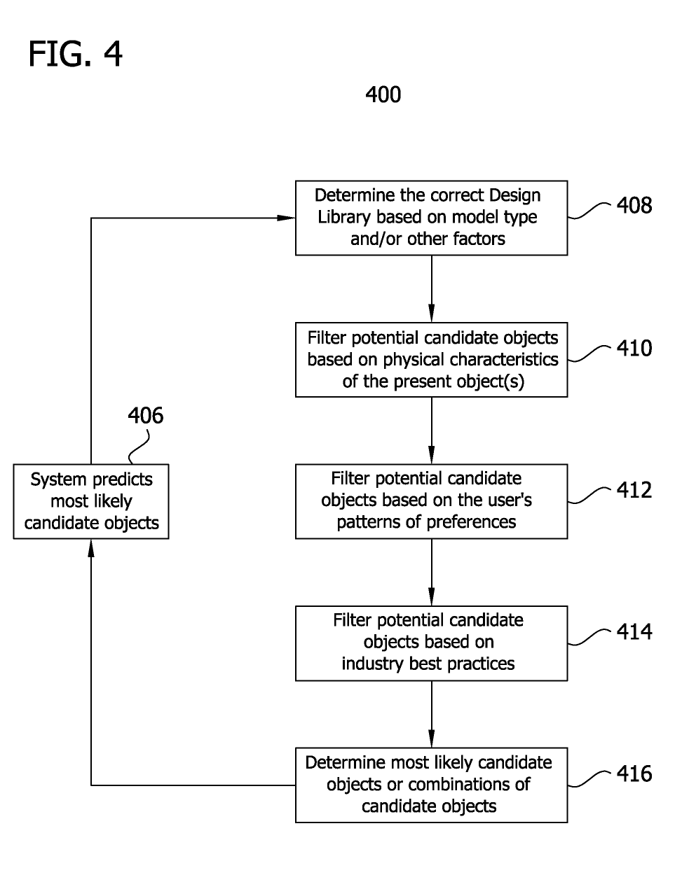

FIG. 4 illustrates an exemplary prediction process suitable for use in FIG. 3 as sub-steps of step 306. The accurate prediction of candidate objects requires consideration of a variety of factors. The step 406 represents the system predicting the most likely candidate objects. Steps 408-416 are sub-steps that can be taken by the system toward the goal of predicting the candidate objects in an embodiment of the invention.

At step 408, for example, the system determines the design library to be used during the prediction. Choice of design library depends on a variety of factors. In one embodiment, there is only one design library and it contains a large number of flowsheet designs from many different types of systems. In this embodiment, no choice is needed. This design library would likely be very large and could potentially require a great deal of time and processing power to properly analyze. Also, because the design library has such a large diversity of types of flowsheet designs, it may not give the most accurate prediction results.

Advantageously, the design library may be divided into useful groups to improve prediction results. Different types of flowsheet designs (e.g., steady-state or dynamic) may be divided into different groups. The divided libraries may be more focused based on design type and more likely to have accurate predictions for those particular types of flowsheets.

A company may maintain its own design library. Rather than drawing from a large group of general flowsheet designs, a company with more unique flowsheet design patterns may maintain a library of its designs in order to improve the prediction of candidate objects. The industry of the company may be a niche that has significantly different requirements than available generic design libraries, such that using a large, general design library may yield inaccurate results, resulting in the mini-palette being ineffective. Additionally, by maintaining a design library, the company has control of which designs are present in the design library. In the event that something about the design library needs to be changed (perhaps a design requirement changed, forcing flowsheets to use different objects going forward), the company can alter the design library as required to reflect the change.

These examples are not intended to limit the possible configurations of design libraries for use with this system, but rather to demonstrate some possible factors that may affect how design libraries may be used.

Design libraries can be stored on the same machine as that which is running the flowsheet design program or they may be stored separately on a server. The design libraries could be maintained in the cloud and updated with new designs from multiple globally distinct locations. The users may then select divided design libraries based on various factors to ensure that the designs in the selected libraries are representative of the flowsheet design being built.

Additional factors may affect the prediction of the candidate objects. Advantageously, the physical characteristics of the present object may be used to limit the selection of potential objects to objects that are compatible with those physical characteristics (step 410). For instance, if the present object is defining a flow of water, the potential objects would be limited to those objects that are compatible with the flow of water, rather than objects that only work with steam or some other material. The chemical makeup of a fluid flowing through the present object may also have an affect on what candidate objects are provided. If the fluid is extremely hot, or acidic, or it reacts with certain other chemicals, the prediction of candidate objects could change dramatically. Similarly, the system may take into account the type of the overall design being made. If the overall design is dynamic, it may call for different potential objects than a design that is steady-state.

In an exemplary case, a user indicates the desire to connect a new object to a heat exchanger object. The heat exchanger object is connected to a stream of full boiling crude, which is a type of fluid that has a vapor phase. The presence of a fluid with a vapor phase limits the potential candidate objects to those that are capable of transporting such fluids. In this case, analysis of the design library indicates that the most likely candidate objects include a heat exchanger, pump, furnace, mixer/splitter, distillation column, blender, flash, desalter, lumper, and basis changer. However, because the fluid flowing through the current object includes a vapor phase, that list is reduced. After filtering for candidate objects that are compatible with a vapor phase fluid, the list of candidate objects is reduced to five: a heat exchanger, a furnace, a mixer/splitter, a distillation column, and a flash. The use of physical characteristics of the present object and the stream or fluid flowing through the object as a filter allows the system to reduce the number of potential candidate objects, increasing the chance of providing the desired candidate object to the user.

Referring further to FIG. 4, a specific user may have certain types of objects or combinations of objects that they prefer to use in their designs. In this case, the system enables detecting a pattern based on the individual user and may be more likely to provide candidate objects that follow that user's patterns (step 412). This allows the system to determine which candidate objects to include in the case of equivalent objects or combinations of objects. In an embodiment, the prediction process uses a user's patterns or preferences in a number of ways. For instance, if there are equivalent objects that may be used as candidates, extra weight is given to the object that the user tends to use more often in the given situation. Additionally, the design library may contain information about who designed each design in the library. In this embodiment, the system considers information about the user to focus on the designs created by the user and/or weigh the statistics from the user's designs more heavily than the others.

A user's region may factor in to the prediction of candidate objects as well. Regional design conventions may cause certain objects to be weighed more heavily than others based on where the user lives. For instance, stream flowsheets designed in the United States have a tendency to use more volumetric flow measurement objects whereas flowsheets designed in Europe tend to use mass flow measurement objects. A user may indicate where they are or where the factory is that is represented by the flowsheet and that may improve the prediction of the candidate object in certain ways.

Referring further to FIG. 4, certain sectors of industry may have best practices that are suggested when designing flowsheets to represent systems of that industry sector. In an embodiment, the system takes these best practices into account when predicting candidate objects (step 414). Once again, there may be equivalent objects or equivalent combinations of objects that may be more likely to be predicted if one of the equivalents is favored over the other based on best practices. Perhaps a best practice requires that after a certain type of object, the design must place a safety valve. In that case, the safety valve may be heavily weighted in the prediction or the best practice rule may override the prediction process such that the mini-palette only displays the required safety valve object. In this way, the user is less likely to forget to follow the best practice and will be reminded that the safety valve is required.

In an exemplary case, a user indicates a desire to connect a new object to the liquid product stream of a crude column's Kerosene side-stripper. The stream is a pure liquid phase and is known to contain 20 components that are trace in quantity that are typically removed from the stream. Analysis of the design library indicates that the most likely candidate objects are: a mixer/splitter, a heat exchanger, a pump, a distillation column, a valve, and a component merger. However, it is an industry best practice to remove the 20 trace components from the stream using a component merger. This best practice may be reflected in the system granting more weight to the component merger object and placing it in the first position of the mini-palette. By emphasizing the component merger object, the user is encouraged or reminded to follow the best practice of including the component merger object as the next object in the stream.

If there are common combinations of candidate objects that follow a present object, these combinations may be presented on the palette as a compound object choice to further streamline the flowsheet design process. Using compound objects as candidates will enable the placement of more complex object units at once, freeing a user from rebuilding the common object combination each time it is needed. The number of objects in a combination is limited by the statistical nature of the analysis. While a two object combination may be very common, a five object combination is likely to be much rarer, due to all the possible variations of a set of five objects.

In predicting the next object, the system considers the object to which the next object will be connected, but the system may also consider multiple objects farther upstream to detect patterns and determine candidate objects. Different combinations of upstream objects may indicate more clearly what is being designed and it may cause the system to provide different sets of candidate objects. For instance, rather than the system using a single valve to attempt to predict the next object, it may use the two previous objects. A boiler-valve combination may indicate different candidate objects than a simple tank-valve combination.

Referring further to FIG. 4, when all the factors to be considered have been determined, the system uses the design library and these factors to predict the most likely candidate objects to present to the user (step 416). The system analyzes the object relationships in the flowsheets in the design library, for example, by counting how many relationships contain the present object(s) to which the new object will be connected. When the system has calculated how many of each potential object appears in a relationship with the present object(s), it ranks the candidate objects based on how many times they appear in a relationship. Any potential objects that are not compatible with any of the predictive factors are preferably removed or weighed less heavily. Any potential objects that may be highlighted by one of the predictive factors may receive extra weight in the ranking of the objects.

Based on the rankings, the system presents the top ranked candidate object(s) to the user and allows the user to choose. The number of candidate objects presented may be any realistic amount but the number should be small enough that the user can quickly identify the candidate objects and determine if the desired object is present. On the other hand, the number of candidate objects should be large enough that all of the most likely candidate objects can be displayed. As shown in FIG. 1, the mini-palette appears as a grid of candidate objects, but it may also appear as a list or any other possible visual grouping that will enable the user to properly determine the next object.

In the event that the mini-palette does not initially display the object desired by the user, the mini-palette may include additional pages or a method of expanding what is displayed (see the mini-palette in FIG. 1, which has an arrow indicating that there are more predictions available). Because the system has ranked many different potential candidate objects, it is likely that the user will find the object in an expanded mini-palette. However, if the desired object is still not there, the user may make use of the regular palette or other method provided by the flowsheet design program for adding objects. The system does not attempt to be 100% correct in predicting next objects, but rather merely provide the correct object a majority of the time in an easily accessed way.

If the user would like to connect a connection port from an object and there are already objects present on the flowsheet to which it may connect, the prediction system can be used to indicate the most likely present objects to which to connect. For instance, if a user is attempting to connect a source object to something and there are already several types of tank objects present on the flowsheet with available connection points, the system may determine that the most likely objects for the connection are the tank objects already present. When this occurs, rather than presenting objects in a mini-palette, the most likely connection points may be highlighted in some manner to indicate that they are the best choices. This indication may include the connection points or objects changing color, size, or appearance in some way. The connection line may snap to the predicted connection points more readily than to other connection points to enable the user to more quickly build the flowsheet.

As an example, prediction of the downstream units for Real Time Optimization (RTO) models is described, based on a library of real-world ethylene plant model simulations. First, all unit pairs are extracted from the models in the library. These large models consist of mostly the separation equipment that occurs downstream of reactors. Table I shows the probability of an object following one of the model's 380 heat exchangers. Table II shows the destinations of the flash vapor. In this example, the top four destinations (italicized), not including “None”, are shown in the mini-palette. Note that the heat exchanger and flash vapor mini-palettes will show different objects.

TABLE I

| HX Destinations | % | Cumulative % |
|---|---|---|
| Flash | 24 | 24 |
| None (unconnected) | 20 | 44 |
| Mixer | 18 | 62 |
| HX | 16 | 78 |
| Splitter | 9 | 87 |
| TrayedSection (column) | 7 | 94 |
| Selector | 1 | 95 |
| CompMerger | 1 | 96 |
| StagingTank | 1 | 97 |
| ConvReactor | 1 | 98 |
| Sink | 0.8 | . . . |
| Valve | 0.8 | . . . |
| SimplePipe | 0.3 | . . . |
| CompSeparator | 0.3 | 100 |

TABLE II

| Flash Vapor Destinations | % | Cumulative % |
|---|---|---|
| Splitter | 34 | 34 |
| StagingTank | 28 | 62 |
| Mixer | 15 | 77 |
| TrayedSection | 12 | 89 |
| Flash | 7 | 95 |
| CompMerger | 2 | 97 |
| HX | 2 | 98 |
| Valve | 2 | 100 |

Tables I and II indicate what percentage of the time each object follows a heat exchanger object. While the body of total objects in the library is quite large, the heat exchanger is only ever connected to a relatively small number of objects, and the most common objects make up the majority of those connection instances. For the heat exchanger, the mini-palette may show the top four candidate objects from the Table I. “None” is not included as the user has already indicated that they want to connect an object to the heat exchanger. From the Flash object down through the Splitter object, Table I indicates that 78% of the time, the desired candidate object would appear in the mini-palette when trying to connect an object to the heat exchanger. For the flash vapor object, Table II indicates that 89% of the time, the desired candidate object would appear in the mini-palette when trying to connect an object to the flash vapor object.

Because objects in flowsheets tend to follow certain patterns repeatedly, even only providing the same four candidate objects for all upstream objects may be enough for the mini-palette to be accurate a majority of the time. The mini-palette is not limited to only displaying four candidate objects.

For purposes of illustration, programs and other executable program components, such as the operating system, are illustrated herein as discrete blocks. It is recognized, however, that such programs and components reside at various times in different storage components of a computing device, and are executed by a data processor(s) of the device.

Although described in connection with an exemplary computing system environment, embodiments of the aspects of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well-known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the invention may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments of the aspects of the invention may be implemented with processor-executable instructions. The processor-executable instructions may be organized into one or more processor-executable components or modules on a tangible processor readable storage medium. Aspects of the invention may be implemented with any number and organization of such components or modules. For example, aspects of the invention are not limited to the specific processor-executable instructions or the specific components or modules illustrated in the figures and described herein. Other embodiments of the aspects of the invention may include different processor-executable instructions or components having more or less functionality than illustrated and described herein.

The order of execution or performance of the operations in embodiments of the aspects of the invention illustrated and described herein is not essential, unless otherwise specified. That is, the operations may be performed in any order, unless otherwise specified, and embodiments of the aspects of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the aspects of the invention are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the aspects of the invention by way of example and not by way of limitation. This description enables one skilled in the art to make and use the aspects of the invention, and describes several embodiments, adaptations, variations, alternatives and uses of the aspects of the invention, including what is presently believed to be the best mode of carrying out the aspects of the invention. Additionally, it is to be understood that the aspects of the invention is not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

Having described aspects of the invention in detail, it will be apparent that modifications and variations are possible without departing from the scope of aspects of the invention as defined in the appended claims. It is contemplated that various changes could be made in the above constructions, products, and process without departing from the scope of aspects of the invention. In the preceding specification, various preferred embodiments have been described with reference to the accompanying drawings. It will, however, be evident that various modifications and changes may be made thereto, and additional embodiments may be implemented, without departing from the broader scope of the aspects of the invention as set forth in the claims that follow. The specification and drawings are accordingly to be regarded in an illustrative rather than restrictive sense.

What is claimed is:

1. A computer-implemented method for generating a graphical flowsheet for modeling a process control system, the method comprising:
receiving an indication from a user to initiate a new connection from a port of a first object currently displayed on a canvas;
applying a set of rules to a plurality of previously designed flowsheets, said rules determining a set of one or more candidate objects based on the currently displayed first object; and
displaying the set of one or more candidate objects to a user in a mini-palette associated with the canvas, wherein the one or more candidate objects are selectable by the user for inclusion on the canvas for generating the graphical flowsheet.

2. The computer-implemented method of claim 1, wherein the set of rules comprises a rule defining the candidate objects as objects that are most often connected in the plurality of previously designed flowsheets to objects of the type of the first object.

3. The computer implemented method of claim 1, wherein the set of rules comprises a rule defining the candidate objects as objects that are compatible with physical characteristics of a process of the process control system flowing through the first object.

4. The computer implemented method of claim 1, further comprising storing a user profile including preferences for connecting objects in the flowsheet and wherein the set of rules comprises a rule defining the candidate objects as objects that are compatible with the preferences included in the user profile.

5. The computer implemented method of claim 1, wherein the set of rules comprises a rule defining the candidate objects as objects that are most compatible with a set of predetermined best practices.

6. The computer implemented method of claim 1, wherein the set of rules comprises a rule defining the candidate objects as objects that are most compatible with a type of flowsheet being designed.

7. The computer implemented method of claim 1, wherein an object of the set of one or more candidate objects is a compound object comprised of a plurality of objects in combination.

8. The computer implemented method of claim 1, wherein a second object is displayed in connection with the first object and wherein the set of rules comprises a rule defining the candidate objects as objects that are most often connected in the plurality of previously designed flowsheets to the combination of objects of the types of the first and second objects.

9. The computer implemented method of claim 1, wherein the mini-palette is displayed as a grid and the candidate objects are displayed as images representative of the objects on the grid.

10. A non-transitory computer readable medium storing processor executable instructions that, when executed, present a mini-palette of candidate objects to a user based on physical characteristics of a process stream to be transferred between the objects for use in generating a graphical flowsheet modeling an industrial process, said instructions comprising:
receiving an indication from the user to initiate a new connection from a port of a first object currently displayed on a canvas;
applying a set of rules to a plurality of previously designed flowsheets, said rules determining a set of one or more candidate objects based on the currently displayed first object; and
displaying the set of one or more candidate objects to a user in a mini-palette associated with the canvas, wherein the one or more candidate objects are selectable by the user for inclusion on the canvas for generating the graphical flowsheet.

11. The computer readable medium of claim 10 wherein the set of rules comprises a rule defining the candidate objects as objects that are most often connected in the plurality of previously designed flowsheets to objects of the type of the first object.

12. The computer readable medium of claim 10 wherein the set of rules comprises a rule defining the candidate objects as objects that are compatible with physical characteristics of the industrial process flowing through the first object.

13. The computer readable medium of claim 10, further comprising storing a user profile including preferences for connecting objects in the flowsheet and wherein the set of rules comprises a rule defining the candidate objects as objects that are compatible with the preferences included in the user profile.

14. The computer readable medium of claim 10 wherein the set of rules comprises a rule defining the candidate objects as objects that are most compatible with a set predetermined of best practices.

15. The computer readable medium of claim 10 wherein the set of rules comprises a rule defining the candidate objects as objects that are most compatible with a type of flowsheet being designed.

16. The computer readable medium of claim 10, wherein an object of the set of one or more candidate objects is a compound object comprised of a plurality of objects in combination.

17. The computer readable medium of claim 10, wherein a second object is displayed in connection with the first object and wherein the set of rules comprises a rule defining the candidate objects as objects that are most often connected in the plurality of previously designed flowsheets to the combination of objects of the types of the first and second objects.

18. The computer readable medium of claim 10, wherein the mini-palette is displayed as a grid and the candidate objects are displayed as images representative of the objects on the grid.

19. A system for generating a flowsheet for modeling an industrial process comprising:
a processor;
a display displaying a user interface;
a memory storing processor executable instructions, said instructions, when executed by the processor, performing operations comprising:
displaying, on the display, a first object representing a component of a process;
receiving, via the user interface, an indication from a user to initiate a new connection from a port of a currently displayed first object;
applying a set of rules to a plurality of previously designed flowsheets as a function of the currently displayed first object;
searching a library of available objects to determine a set of one or more candidate objects based on the applied rules; and
displaying, on the display, the set of one or more candidate objects to the user in a mini-palette, wherein the one or more candidate objects are selectable by the user via the user interface for inclusion in the flowsheet.

20. The system of claim 19 wherein the set of rules comprises a rule defining the candidate objects as objects that are most often connected in the plurality of previously designed flowsheets to objects of the type of the first object.

21. The system of claim 19 wherein the set of rules comprises a rule defining the candidate objects as objects that are compatible with physical characteristics of a process flowing through the first object.

22. The system of claim 19 further comprising storing a user profile including preferences for connecting objects in the flowsheet and wherein the set of rules comprises a rule defining the candidate objects as objects that are the most compatible with the preferences included in the user profile.

23. The system of claim 19 wherein the set of rules comprises a rule defining the candidate objects as objects that are most compatible with a set of predetermined best practices.

24. The system of claim 19 wherein the set of rules comprises a rule defining the candidate objects as objects that are most compatible with a type of flowsheet being designed.

25. The system of claim 19, wherein an object of the set of one or more candidate objects is a compound object comprised of a plurality of objects in combination.

26. The system of claim 19, wherein a second object is displayed in connection with the first object and wherein the set of rules comprises a rule defining the candidate objects as objects that are most often connected in the plurality of previously designed flowsheets to the combination of objects of the types of the first and second objects.

27. The system of claim 19, wherein the mini-palette is displayed as a grid and the candidate objects are displayed as images representative of the objects on the grid.
